(19) United States
(12) Patent Application Publication
(10) Pub. No.: US 2011/0183287 A1
(43) Pub. Date: Jul. 28, 2011

(54) BONE INFUSER FOR AN OSSEOUS TISSUE IMPLANTING SYRINGE

(76) Inventor: Dalho Lee, Seoul (KR)

(21) Appl. No.: 13/063,138

(22) PCT Filed: Jul. 24, 2009
(86) PCT No.: PCT/KR2009/004127

§ 371 Date: Mar. 9, 2011

(30) Foreign Application Priority Data
Sep. 11, 2008 (KR) 10-2008-0089717

(51) Int. Cl. A61C 5/04

(52) U.S. Cl. 433/90

(57) ABSTRACT

The present disclosure provides a dental device comprising: a tube having a cone-shape protrusion; a first bone infuser containing a spiral groove formed at the top end, a spiral hole formed on a cylindrical body, and an introduction groove formed in the first bone infuser; and a second bone infuser containing a spiral groove configured to mate with the spiral hole of the first infuser, a plurality of nozzles, and an introduction groove formed in the second bone infuser.

### FIELD

The present invention relates to a bone infuser for an osseous tissue implanting syringe, and more particularly to one which can be selectively used in combination with the syringe when implanting a bone graft in order to reinforce an artificial dental implant during oral implant surgery, thereby allowing bone graft implantation to be performed in a convenient, rapid, easy, and efficient manner even in the event of implanting an upper molar or the like that requires much labor, or in the event where a large amount of the bone graft is implanted.

### BACKGROUND

Recently, dental implant surgeries are broadly performed in order to implant artificial teeth. Such an implant surgery is accompanied by several operations depending on the state of the oral cavity of a patient. In particular, if the alveolar bone into which an artificial dental root is to be implanted is weak, a process of bone graft implantation is performed on a region into which the artificial dental root is to be implanted in order to reinforce the alveolar bone. Since natural or artificial bone grafts are very expensive, doctors pay particular attention when they treat the grafts.

In the related art, as shown in FIG. 1, an existing process of implanting a bone graft into a region into which an artificial dental root is to be implanted involves implanting the bone graft into the region using a common syringe. However, the existing process of using a common syringe 1 has undergone problems in that a bone graft 30 leaks out or is not ejected at a sufficient depth inside a hole formed in the region, since the size of the leading end of a protrusion 2a in the front portion of a tube 2 is too large or small compared to that of the hole. In particular, in the case of implanting the bone graft into the upper molar using this common syringe, many difficulties are caused, thereby requiring a long time to be spent on the implantation. Since the common syringe is not structured to facilitate an implantation operation, it is difficult to efficiently perform the implantation operation. In addition, if the implantation operation is performed immoderately, the gum of a patient may be damaged. As such, the existing implantation process involves many potential problems.

### SUMMARY OF THE INVENTION

### Technical Problem

Accordingly, the present invention has been made keeping in mind the above problems occurring in the prior art, and an object of the present invention is to provide a bone infuser for an osseous tissue implanting syringe, which can be selectively used in combination with the syringe when implanting a bone graft for reinforcing an artificial dental implant during oral implant surgery, thereby not only allowing bone graft implantation to be performed in a convenient, rapid, easy, and efficient manner—even in the event of implanting an upper molar or the like that requires much labor, or in the event where a large amount of the bone graft is implanted—but also reducing the time taken for implantation and achieving a maximized effect of oral implant surgery, since the bone graft can be implanted without causing damage to the gum or the like of a patient.

### Technical Solution

In order to realize the foregoing object, the present invention provides a bone infuser for an osseous tissue implanting syringe, which includes a cylindrical tube having a protrusion at a leading end thereof and a piston for reciprocating inside the tube in order to press a bone graft toward the protrusion. The bone infuser includes the tube having the protrusion at the leading end thereof, a first infuser, and a second infuser. The protrusion has a form of a cone. One end of the first infuser is open and the other end of the first infuser is closed. The first infuser has an introduction groove therein, so that the bone graft that is ejected through a nozzle inside the protrusion is introduced through the introduction groove, a spiral groove in an inner surface on one end thereof, so that the protrusion is forcibly coupled to the spiral groove in a fitted state during implantation of the bone graft, and an arc-shaped curved portion in an inner surface on the other end thereof, so that the bone graft that is ejected through the nozzle of the protrusion is properly guided by the curved portion. One end of the second bone infuser is open and the other end of the second bone infuser is closed. The second bone infuser and has a spiral groove in an outer circumference on one end thereof, the spiral groove being spirally coupled to the spiral hole of the first infuser, an introduction groove inside thereof, so that the bone graft that has passed through the first bone infuser is introduced through the introduction groove, and a plurality of nozzles along a circumference of the other end thereof, so that the bone graft is radially ejected through the nozzles.

In addition, the second bone infuser is characterized by being open at both ends thereof, and having a spiral groove in an outer circumference of one end thereof, so that the spiral groove is spirally coupled to the spiral hole of the first bone infuser, and a nozzle inside thereof, wherein the nozzle is configured to extend through the bone infuser.

In addition, the first and second bone infusers are characterized by being integral to each other.

### Advantageous Effects

As set forth above, the bone infuser for an osseous tissue implanting syringe of the invention can be selectively used in combination with the syringe when implanting a bone graft for reinforcing an artificial dental implant during oral implant surgery, thereby not only allowing bone graft implantation to be performed in a convenient, rapid, easy, and efficient manner—even in the event of implanting an upper molar or the like that requires much labor, or in the event where a large amount of the bone graft is implanted—but also reducing the time taken for implantation. A maximized effect of oral implant surgery can be achieved since the bone graft can be implanted without causing damage to the gum or the like of a patient. Furthermore, the bone infuser is not disposable but can be reused after being sterilized. Therefore, the present invention provides a variety of advantages and is thus very useful.

### BRIEF DESCRIPTION OF THE DRAWINGS

FIG. 1 is a longitudinal cross-sectional view showing an osseous tissue implanting syringe of the related art;

FIG. 2 is an exploded perspective view showing an embodiment of the present invention;

FIG. 3 is a perspective view showing the assembled state of FIG. 2;

FIG. 4 is a longitudinal cross-sectional view showing the assembled state of FIG. 2; and

FIG. 5 is a longitudinal cross-sectional view showing another embodiment of the present invention.

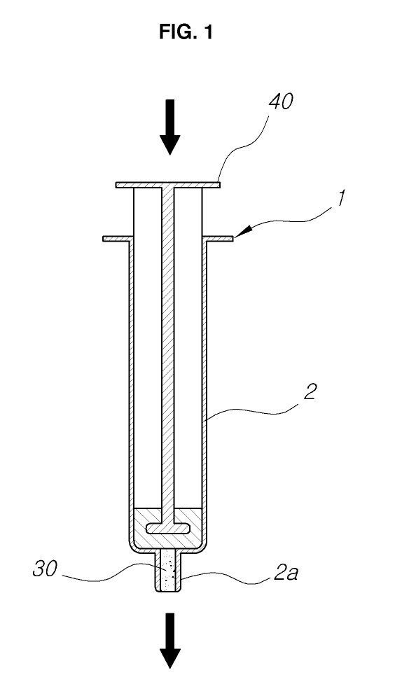

Major Reference Numerals of the Drawings

| | |
|---|---|
| 10: syringe | 20: tube |
| 22: protrusion | 24, 66, 68: nozzle |
| 30: bone graft | 40: piston |
| 50: first bone infuser | 52, 64: introduction groove |
| 54, 62: spiral groove | 56: curved portion |
| 58: spiral hole | 60: second bone infuser |

### DETAILED DESCRIPTION OF THE INVENTION

The present invention will now be described more fully hereinafter with reference to the accompanying drawings, in which preferred embodiments thereof are shown.

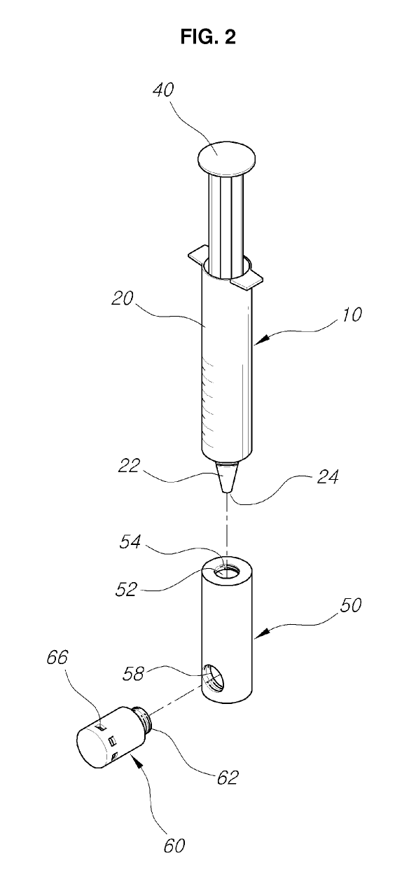

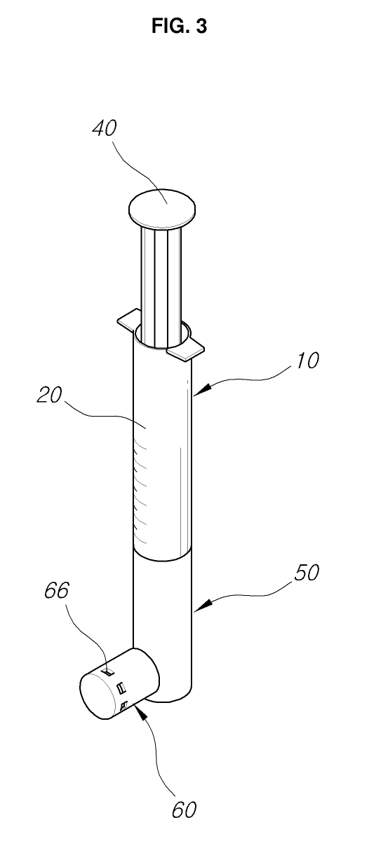

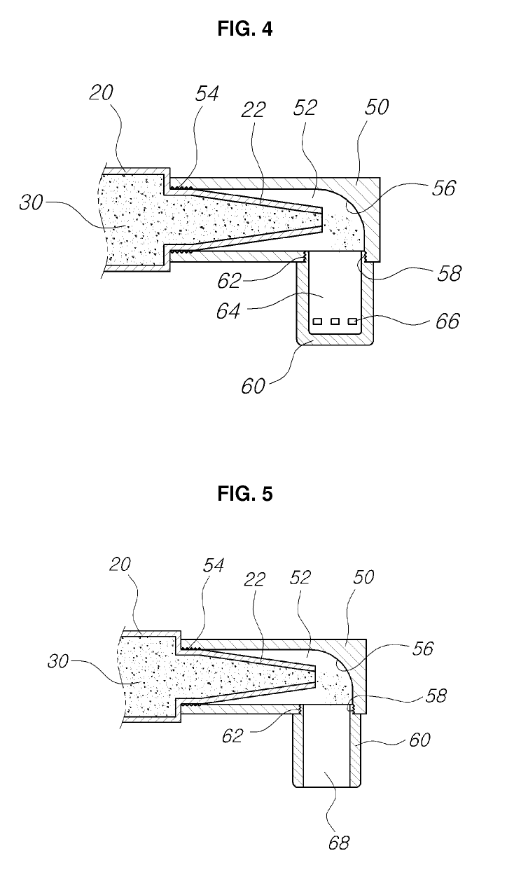

FIG. 2 is an exploded perspective view showing an embodiment of the present invention, FIG. 3 is a perspective view showing the assembled state of FIG. 2, FIG. 4 is a longitudinal cross-sectional view showing the assembled state of FIG. 2, and FIG. 5 is a longitudinal cross-sectional view showing another embodiment of the present invention.

As shown in FIGS. 2 to 4, in the bone infuser for an osseous tissue implanting syringe of the invention, a protrusion 22 is formed on the leading end of a tube 20 of a syringe 10. The protrusion 22 has the form of a cone, and the tube 20 has the form of a cylinder. A piston 40, which linearly reciprocates when pressing a bone graft 30 toward the protrusion 22, is fitted in the tube 20.

In addition, a first infuser 50 is open at one end and is closed at the other end. The first infuser 50 has an introduction groove 52 therein so that the bone graft 30 that is ejected through a nozzle 24 inside the protrusion 22 is introduced through the introduction groove 52. The first infuser 50 has defined a spiral groove 54 in the inner surface on one end thereof. The protrusion 22 is forcibly coupled to spiral groove 54 in the fitted state during the implantation of the bone graft 30. In the inner surface on the other end of the first infuser 50, a curved portion 56 having the form of an arc is formed. The curved portion 56 serves to properly guide the bone graft 30 that is ejected through the nozzle 24 of the protrusion 22. A spiral hole 58 is formed on the lower portion of the other end of the first infuser 50.

In addition, a second bone infuser 60 is open at one end and is closed at the other end. The second bone infuser 60 has defined a spiral groove 62 in the outer circumference on one end. The spiral groove 62 is spirally coupled to the spiral hole 58 of the first infuser 50. An introduction groove 64 is formed inside the second bone infuser 60. The bone graft 30 that has passed through the first bone infuser 50 is introduced into the introduction groove 64. A plurality of nozzles 66 is formed along the circumference of the other end of the second bone infuser 60, and serves to radially eject the bone graft 30.

As shown in FIG. 5, another embodiment of the second infuser 60, which is open at both ends, can be used to implant the bone graft 30. The second infuser 60 has defined a spiral groove 62 in the outer circumference of one end thereof. The spiral groove 62 is spirally coupled to the spiral hole 58 of the first bone infuser 50. The second bone infuser 50 does not have the multiple nozzles 66, which are intended to radially eject the bone graft 30, in the circumference thereof, but has defined a nozzle 68 extending through the inside thereof.

In the present invention as configured above, as shown in FIGS. 2 to 4, when intending to implant the bone graft in a region into which an artificial dental root is to be implanted, for example, in an upper molar or the like that requires much labor, during dental implantation surgery, the first infuser 50, which is open at one end and is closed at the other end, and the second bone infuser 60, which is open at one end and is closed at the other end, are coupled to each other by rotation in the state in which the spiral groove 62 on the outer circumference of one end of the second infuser 60 is fitted into the spiral hole 58 in the lower portion of the other end of the first infuser 50.

Afterwards, the tube 20 filled with a predetermined amount of the bone graft 30 is integrally coupled to the first and second bone infusers 50 and 60 by forcibly pressing the conical protrusion 22, which is formed at the leading end of tube 20, into the open introduction groove 52 on one end of the first infuser 50 in the state in which the protrusion 22 is fitted into the introduction groove 52. Then, the other end of the second infuser 60 is fitted into a hole that is formed in a region into which implantation is to be performed. In this state, it is possible to conveniently implant the bone graft 30 by pressing the piston 40, which is fitted into the tube 20, so that the bone graft 30 is ejected through the nozzle 24 of the conical protrusion 22 at the leading end of the tube 20 into the first bone infuser 50, and then through the multiple nozzles 66 in the circumference of the other end of the second bone infuser 60 into the hole of the implanting region.

In the event of implanting the bone graft 30, the second bone infuser 60 can be substituted, if necessary, by the second bone infuser 60 having the form shown in FIG. 5. In a typical surgery, the implantation operation is performed using the second bone infuser 60 shown in FIG. 5. In the event of implanting a large amount of the bone graft 30, the second bone infuser 60 having the multiple nozzles 66 in the circumference of the other end thereof, as shown in FIG. 4, is used to implant the bone graft 30 around the implanting region, and then the second bone infuser 60 having the nozzle 68 configured to extend through the inside thereof, as shown in FIG. 5, is used to proceed the implantation operation.

In addition, since the other end of the second bone infuser 60 is fitted into a minute hole into which an artificial dental root is to be implanted, its thickness and length correspond to those of the hole that are determined according to the laryngeal width. The second bone infuser 60 can be fabricated by dividing it into regular and wide types depending on the thickness, if necessary, and into several types depending on the length, so that the bone graft 30 can be ejected at a sufficient depth without leaking out.

In addition, the spiral groove 54 formed in the inner surface of one end of the first infuser 50 has the following effect: After the tube 20 made of a synthetic resin is forcibly coupled to the first infuser 50 by rotation in the state in which the protrusion 22 of the tube 20 is fitted to the spiral groove 54 of the first infuser 50, when the piston 40 is pressed in order to implant the bone graft 30, the bone graft 30 can be easily inserted into the first and second infusers 50 and 60 without pushing the piston 40 backward.

In addition, since the curved portion 54 having the form of an arc is formed in the inner surface of the other end of the introduction groove 52 of the first infuser 50, the bone graft 30 that is ejected through the nozzle 26 of the protrusion 22 can be guided along the curved portion 54, thereby easily entering into the second bone infuser 60.

Furthermore, since the multiple nozzles 66 are formed in the circumference of the other end of the second bone infuser 60, the bone graft 30 can be ejected by being radially diverged without being ejected in one direction. As a result, the bone graft 30 can be rapidly ejected so that it is uniformly distributed.

Moreover, the first and second bone infusers 50 and 60 can be separately fabricated in a detachable type so that they can be reused after being sterilized. Alternatively, the first and second infusers 50 and 60 can be used by being integrally fabricated.

While the present invention has been shown and described with reference to the certain exemplary embodiments thereof and the accompanying drawings, the present invention is by no means limited thereto. It will be understood that various modifications can be made therein without departing from the spirit of the present invention and within the scope of the appended claims.

1-3. (canceled)

4. A dental device comprising:
a tube having a cone-shape protrusion;
a first bone infuser having a cylindrical shape with a top end and a bottom end, the first bone infuser containing:
a spiral groove formed at the top end, the spiral groove configured to couple with the cone-shape protrusion,
a spiral hole formed on a cylindrical body of the first bone infuser, and
an introduction groove formed in the first bone infuser, the introduction groove providing a passage for a bone graft from the tube to the spiral hole, wherein the introduction groove has an arc-shaped portion to guide the bone graft to a second bone infuser through the spiral hole; and
a second bone infuser having an open end and a closed end, the second bone infuser containing:
a spiral groove at the open end, the spiral groove configured to mate with the spiral hole of the first infuser,
a plurality of nozzles formed on a cylindrical body of the second bone infuser, the nozzles configured to eject the bone graft radially, and
an introduction groove formed in the second bone infuser, the introduction groove providing a passage for the bone graft from the first bone infuser to the plurality of nozzles.

5. The dental device according to claim 4, wherein the first and second bone infusers are provided as a single unit.

6. A dental device comprising:
a tube having a cone-shape protrusion;
a first bone infuser having a cylindrical shape with a top end and a bottom end, the first bone infuser containing:
a spiral groove formed at the top end, the spiral groove configured to couple with the cone-shape protrusion,
a spiral hole formed on a cylindrical body of the first bone infuser, and
an introduction groove formed in the first bone infuser, the introduction groove providing a passage for a bone graft from the tube to the spiral hole, wherein the introduction groove has an arc-shaped portion to guide the bone graft to a second bone infuser through the spiral hole; and
a second bone infuser having a cylindrical shape, the second bone infuser containing:
a top end having a spiral groove configured to mate with the spiral hole of the first infuser,
a bottom end having an opening, and
an introduction groove formed in the second bone infuser, the introduction groove providing a passage for the bone graft to the opening.

7. The dental device according to claim 6, wherein the first and second bone infusers are provided as a single unit.
